(19) United States
(12) Patent Application Publication
(10) Pub. No.: US 2015/0361208 A1
(43) Pub. Date: Dec. 17, 2015

(54) HYBRID LATEX COMPRISING POLYMERIC PARTICLES HAVING CORE-SHELL STRUCTURE AND ITS PREPARATION METHOD

(71) Applicant: BASF SE, Ludwigshafen (DE)

(72) Inventors: Shengxian WANG, Shanghai (CN); Wei HONG, Shanghai (CN); Yaxian ZHAI, Shanghai (CN); Joachim PAKUSCH, Speyer (DE)

(73) Assignee: BASF SE, Ludwigshafen (DE)

(21) Appl. No.: 14/765,169

(22) PCT Filed: Jan. 24, 2014
(86) PCT No.: PCT/EP2014/051378

§ 371 Date: Jul. 31, 2015

(30) Foreign Application Priority Data
Feb. 6, 2013 (CN) PCT/CN2013/071428

(51) Int. Cl. C08F 265/10; C04B 24/26

(52) U.S. Cl. CPC C08F 265/10; C04B 24/2641

(57) ABSTRACT

The invention relates to a hybrid latex comprising polymeric particles having core-shell structure, wherein: (1) the comonomers of the core comprise: (a) monovinyl aromatic compounds, and (b) unsaturated carboxylic acid esters; (2) the comonomers of the shell comprise: (a) monovinyl aromatic compounds, and (b) conjugated dienes; wherein the glass transition temperature of the core is in the range of −50° C. to 50° C., and the glass transition temperature of the shell is in the range of −50° C. to 50° C. The invention also relates to the use of the hybrid latex in polymer waterproofing membrane and polymer modified mortars.

### TECHNICAL FIELD

The invention relates to a hybrid latex comprising polymeric particles having core-shell structure and its preparation method. The invention also relates to the use of the hybrid latex in polymer waterproofing membrane and polymer modified mortars.

### BACKGROUND OF ART

Cement based building materials are the foundation for modern constructions with extensive utilization. However, the tensile strength, adhesion strength, fracture toughness, impermeability, corrosion resistance, abrasion resistance, resistance to cracking and durability etc are not desirable due to its nature of porousness and brittleness, and thus its application needs significant modification in some fields, such as flexible cement based waterproof membrane, cement based tile adhesive, waterproof mortar, corrosion resistant mortar, repair mortar, cement based primer, etc. The above properties can be improved substantially by modification with polymer, especially polymer emulsion. Many polymer emulsions have been used in the modification of cement, such as acrylic latex, ethylene-vinyl acetate latex, chloroprene latex, styrene-butadiene latex, acrylonitrile-butadiene latex, natural rubber latex etc, wherein styrene-butadiene latex are used widely and commonly in the modification of cement based materials due to its excellent hydrophobicity and saponification resistance.

However, since automotive industry develops rapidly in the last decade, the demand of rubber for tyre is increasing. In addition, styrene-butadiene rubber is gradually replacing natural rubber due to its relative low cost and easy availability. Thus, the price of butadiene is increasing rapidly such that the cost of styrene-butadiene latex is rapidly increasing accordingly. This lead to a serious impact on some fields which are more sensitive to cost, such as paper, carpet, adhesive and construction materials, e.g. styrene-butadiene latex modified cement based materials, etc. Therefore, there is a need to find an alternative which can replace the prior styrene-butadiene latex or can reduce its cost without sacrificing its performance.

### INVENTION SUMMARY

Thus, the invention provides a hybrid latex comprising polymeric particles having core-shell structure, wherein:

(1) the comonomers of the core comprise:
(a) monovinyl aromatic compounds, and
(b) unsaturated carboxylic acid esters;

(2) the comonomers of the shell comprise:
(a) monovinyl aromatic compounds, and
(b) conjugated dienes;

wherein the glass transition temperature of the core is in the range of −50° C. to 50° C., and the glass transition temperature of the shell is in the range of −50° C. to 50° C.

The invention also provides the use of the hybrid latex in polymer waterproofing membrane and polymer modified mortars.

The problem in the prior art is solved by modifying styrene-butadiene latex with unsaturated carboxylic acid esters in the present invention. In the hybrid latex of the invention, butadiene is replaced partially by unsaturated carboxylic acid esters having lower cost such that the cost of styrene-butadiene latex decreases largely. Since the polymeric particles have core-shell structure, the styrene-butadiene copolymer is present in the shell of polymeric particles and thus some excellent properties of styrene-butadiene latex remain, such as hydrophobicity and saponification resistance etc. In addition, in order to meet different applications, composition in either core or shell can vary independently and the properties of the latex can vary widely by designing the composition of the polymers, for example changing gradually from flexible material to rigid material.

### EMBODIMENTS

In one embodiment of the present invention, the invention provides a hybrid latex comprising polymeric particles having core-shell structure, wherein:

(1) the comonomers of the core comprise:
(a) monovinyl aromatic compounds, and
(b) unsaturated carboxylic acid esters;

(2) the comonomers of the shell comprise:
(a) monovinyl aromatic compounds, and
(b) conjugated dienes;

wherein the glass transition temperature of the core is in the range of −50° C. to 50° C., and the glass transition temperature of the shell is in the range of −50° C. to 50° C.

In one embodiment of the present invention, the glass transition temperature of the core is in the range of −20° C. to 20° C., preferably −10° C. to 10° C.

In one embodiment of the present invention, the glass transition temperature of the shell is in the range of −20° C. to 20° C., preferably −20° C. to 0° C.

In one embodiment of the present invention, the unsaturated carboxylic acid ester is selected from the group consisting of C1-C8 alkyl (meth)acrylates, preferably methyl (meth)acrylate, ethyl (meth)acrylate, butyl (meth)acrylate, 2-ethylhexyl (meth)acrylate, and combination thereof, more preferably n-butyl acrylate.

In one embodiment of the present invention, the monovinyl aromatic compound is selected each independently from the group consisting of styrene, methyl styrene, ethyl styrene, and combination thereof, preferably styrene.

In one embodiment of the present invention, the conjugated diene is selected from the group consisting of 1,3-butadiene, isoprene, 2-chloro-1,3-butadiene, and combination thereof, preferably 1,3-butadiene.

In one embodiment of the present invention, the comonomers of the core comprise 10-90 wt %, preferably 30-70 wt %, more preferably 50-70 wt % of unsaturated carboxylic acid esters and 90-10 wt %, preferably 70-30 wt %, more preferably 50-30 wt % of monovinyl aromatic compounds, and the weight percentages are calculated based on the total weight of the comonomers of the core and the sum of all comonomers of the core is 100 wt %; the comonomers of the shell comprise 10-90 wt %, preferably 30-70 wt %, more preferably 40-60 wt % of conjugated dienes and 90-10 wt %, preferably 70-30 wt %, more preferably 60-40 wt % of monovinyl aromatic compounds, and the weight percentages are calculated based on the total weight of the comonomers of the shell and the sum of all comonomers of the shell is 100 wt %.

In one embodiment of the present invention, the core comprises 10-90 wt %, preferably 20-80 wt %, more preferably 30-70 wt % of the weight of the polymeric particles, and the shell comprises 90-10 wt %, preferably 80-20 wt %, more preferably 70-30 wt % of the weight of the polymeric particles.

In one embodiment of the present invention, the polymeric particles have a particle size of 80 to 300 nm.

In one embodiment of the present invention, the comonomers of the core further comprise 0-10 wt %, preferably 1-5 wt % of monomers selected from the group consisting of (meth)acrylic acid, (meth)acrylamide, N-hydroxymethyl (meth)acrylamide, itaconic acid, maleic acid, fumaric acid, hydroxyethyl (meth)acrylate, hydroxypropyl (meth)acrylate, sodium vinyl sulfonate, sodium styrene sulfonate, acrylonitrile, glycidyl methacrylate, diacetone acrylamide, vinyltrimethoxy silane, γ-methacryloxy propyl trimethoxyl silane, allyl acrylate, 1,4-butanediol diacrylate, trihydroxymethyl propane triacrylate, pentaerythritol tetraacrylate, and combination thereof, and the weight percentages are calculated based on the total weight of the comonomers of the core and the sum of all comonomers of the core is 100 wt %.

In one embodiment of the present invention, the comonomers of the shell further comprise 0-10 wt %, preferably 1-5 wt % of monomers selected from the group consisting of (meth)acrylic acid, (meth)acrylamide, N-hydroxymethyl (meth)acrylamide, itaconic acid, maleic acid, fumaric acid, hydroxyethyl (meth)acrylate, hydroxypropyl (meth)acrylate, sodium vinyl sulfonate, sodium styrene sulfonate, acrylonitrile, glycidyl methacrylate, diacetone acrylamide, vinyltrimethoxy silane, γ-methacryloxy propyl trimethoxyl silane, allyl acrylate, 1,4-butanediol diacrylate, trihydroxymethyl propane triacrylate, pentaerythritol tetraacrylate, and combination thereof, and the weight percentages are calculated based on the total weight of the comonomers of the shell and the sum of all comonomers of the shell is 100 wt %.

In one embodiment of the present invention, the hybrid latex can also comprise a conventional additive in the art, such as pigments, biocide, defoamer, antioxidant, etc.

The invention also provides the use of the hybrid latex in polymer waterproofing membrane and polymer modified mortars.

In one preferred embodiment of the present invention, the polymer waterproofing membrane are cementitious based polymer waterproofing membrane.

In one preferred embodiment of the present invention, the polymer modified mortars are selected from the group consisting of cement based tile adhesive, repair mortar, waterproofing mortar, self-leveling mortar, exterior thermal insulation adhesive mortar and decorative mortar, thermal insulation mortar, flooring mortar and cement based interfacial agents.

In the context of the present invention, tensile strength, adhesion strength and elongation at break are measured according to GB/T 1677-2008, “Test Method of Building Waterproofing Coatings”, 1^{st} edit, June, 2008; the glass transition temperature of the polymers are measured according to GB/T 19466.2-2004, “Plastics, Differential Scanning calorimetry (DSC), 1^{st} edit, March, 2004”.

All percentages are mentioned by weight unless otherwise indicated.

### EXAMPLES

The present invention is now further illustrated by reference to the following examples, however, the examples are used for the purpose of explanation and not intended to limit the scopes of the invention.

### Example 1

| | | |
|---|---|---|
| Initial charge: | Demineralized water | 440.0 g |
| | Aqueous solution of the tetrasodium salt of | 20.0 g |
| | ethylenediaminetetraacetic acid (Trilon B, 2%) | |
| | Seed T6772 (solid content of 33%, from | 30.3 g |
| | Shanghai Gaoqiao BASF Dispersions Co., Ltd.) | |
| Feed 1: | Demineralized water | 560.0 g |
| | Sodium lauryl alcohol ether sulfate (Texapon NSO IS) | 71.4 g |
| | Nonionic emulsifier Lutensol TO 89 | 6.7 g |
| | Tetrasodium pyrophosphate solution (3%) | 333.3 g |
| | Acrylic acid | 4.0 g |
| | Acrylamide solution (15%) | 266.7 g |
| Feed 2: | (a) Styrene | 110.0 g |
| | n-butyl acrylate | 200.0 g |
| | (b) Styrene | 906.0 g |
| | Butadiene | 740.0 g |
| | Tert-dodecyl mercaptan | 16.0 g |

The initial charges are added into stainless steel reactor under nitrogen gas with stirring (200 rpm). When the temperature in the reactor arrives at 70-90° C., 28.6 g of sodium persulfate solution (7%) is added for 5 minutes. Then Feed 1, 200 g of sodium persulfate solution (7%) and Feed 2 are added dropwise simultaneously and the addition time are 3-6 hours, wherein Feed 2 is added dropwise in two parts (a) and (b), and part (a) is first added dropwise and then part (b) is added dropwise. After addition completely, the mixture is kept for 1-2 hours at 70-90° C. to perform post polymerization. Then the mixture is cooled to 65-85° C., and 62.0 g t-butyl hydroperoxide solution (10%) and 69.2 g of acetone sodium bisulfite solution (13%) are added dropwise simultaneously and react for 1-3 hours. Then 60.0 g of sodium hydroxide solution (10%) is added with stirring slowly, and the resulting mixture is cooled to room temperature, and 13.3 g fungicide ACTICIDE MV is added and then the solid content is adjusted to 48-50% by demineralized water. Then the pH value is adjusted to 7-9 by sodium hydroxide solution (10%). Finally the volatile organic compounds in the product are removed by steam stripping.

### Example 2

| | | |
|---|---|---|
| Initial charge: | Demineralized water | 440.0 g |
| | Aqueous solution of the tetrasodium salt of | 20.0 g |
| | ethylenediaminetetraacetic acid (Trilon B, 2%) | |
| | Seed T6772 (solid content of 33%) | 30.3 g |
| Feed 1: | Demineralized water | 560.0 g |
| | Sodium lauryl alcohol ether sulfate (Texapon NSO IS) | 71.4 g |
| | Nonionic emulsifier Lutensol TO 89 | 6.7 g |
| | Tetrasodium pyrophosphate solution (3%) | 333.3 g |
| | Acrylic acid | 4.0 g |
| | Acrylamide solution (15%) | 266.7 g |
| Feed 2: | (a) Styrene | 170.0 g |
| | n-butyl acrylate | 300.0 g |
| | (b) Styrene | 826.0 g |
| | Butadiene | 660.0 g |
| | Tert-dodecyl mercaptan | 14.4 g |

The initial charges are added into stainless steel reactor under nitrogen gas with stirring (200 rpm). When the temperature in the reactor arrives at 70-90° C., 28.6 g of sodium persulfate solution (7%) is added for 5 minutes. Then Feed 1, 200 g of sodium persulfate solution (7%) and Feed 2 are added dropwise simultaneously and the addition time are 3-6 hours, wherein Feed 2 is added dropwise in two parts (a) and (b), and part (a) is first added dropwise and then part (b) is added dropwise. After addition completely, the mixture is kept for 1-2 hour at 70-90° C. to perform post polymerization. Then the mixture is cooled to 65-85° C., and 62.0 g t-butyl hydroperoxide solution (10%) and 69.2 g of acetone sodium bisulfite solution (13%) are added dropwise simultaneously and react for 1-3 hours. Then 60.0 g of sodium hydroxide solution (10%) is added with stirring slowly, and the resulting mixture is cooled to room temperature, and 13.3 g fungicide ACTICIDE MV is added and then the solid content is adjusted to 48-50% by demineralized water. Then the pH value is adjusted to 7-9 by sodium hydroxide solution (10%). Finally the volatile organic compounds in the product are removed by steam stripping.

### Example 3

| | | |
|---|---|---|
| Initial charge: | Demineralized water | 440.0 g |
| | Aqueous solution of the tetrasodium salt of | 20.0 g |
| | ethylenediaminetetraacetic acid (Trilon B, 2%) | |
| | Seed T6772 (solid content of 33%) | 30.3 g |
| Feed 1: | Demineralized water | 560.0 g |
| | Sodium lauryl alcohol ether sulfate (Texapon NSO IS) | 71.4 g |
| | Nonionic emulsifier Lutensol TO 89 | 6.7 g |
| | Tetrasodium pyrophosphate solution (3%) | 333.3 g |
| | Acrylic acid | 4.0 g |
| | Acrylamide solution (15%) | 266.7 g |
| Feed 2: | (a) Styrene | 220.0 g |
| | n-butyl acrylate | 400.0 g |
| | (b) Styrene | 746.0 g |
| | Butadiene | 590.0 g |
| | Tert-dodecyl mercaptan | 13.0 g |

The initial charges are added into stainless steel reactor under nitrogen gas with stirring (200 rpm). When the temperature in the reactor arrives at 70-90° C., 28.6 g of sodium persulfate solution (7%) is added for 5 minutes. Then Feed 1, 200 g of sodium persulfate solution (7%) and Feed 2 are added dropwise simultaneously and the addition time are 3-6 hours, wherein Feed 2 is added dropwise in two parts (a) and (b), and part (a) is first added dropwise and then part (b) is added dropwise. After addition completely, the mixture is kept for 1-2 hours at 70-90° C. to perform post polymerization. Then the mixture is cooled to 65-85° C., and 62.0 g t-butyl hydroperoxide solution (10%) and 69.2 g of acetone sodium bisulfite solution (13%) are added dropwise simultaneously and react for 1-3 hours. Then 60.0 g of sodium hydroxide solution (10%) is added with stirring slowly, and the resulting mixture is cooled to room temperature, and 13.3 g fungicide ACTICIDE MV is added and then the solid content is adjusted to 48-50% by demineralized water. Then the pH value is adjusted to 7-9 by sodium hydroxide solution (10%). Finally the volatile organic compounds in the product are removed by steam stripping.

### Comparative Example

| | | |
|---|---|---|
| Initial charge: | Demineralized water | 440.0 g |
| | Aqueous solution of the tetrasodium salt of | 20.0 g |
| | ethylenediaminetetraacetic acid (Trilon B, 2%) | |
| | Seed T6772 (solid content of 33%) | 30.3 g |
| Feed 1: | Demineralized water | 560.0 g |
| | Sodium lauryl alcohol ether sulfate | 71.4 g |
| | (Texapon NSO IS) | |
| | Nonionic emulsifier Lutensol TO 89 | 6.7 g |
| | Tetrasodium pyrophosphate solution (3%) | 333.3 g |
| | Acrylic acid | 4.0 g |
| | Acrylamide solution (15%) | 266.7 g |
| Feed 2: | Styrene | 1040.0 g |
| | Butadiene | 900.0 g |
| | Tert-dodecyl mercaptan | 24.0 g |

The initial charges are added into stainless steel reactor under nitrogen gas with stirring (200 rpm). When the temperature in the reactor arrives at 70-90° C., 28.6 g of sodium persulfate solution (7%) is added for 5 minutes. Then Feed 1, 200 g of sodium persulfate solution (7%) and Feed 2 are added dropwise simultaneously and the addition time is 3-6 hours. After addition completely, the mixture is kept for 1-2 hours at 70-90° C. to perform post polymerization. Then the mixture is cooled to 65-85° C., and 62.0 g t-butyl hydroperoxide solution (10%) and 69.2 g of acetone sodium bisulfate solution (13%) are added dropwise simultaneously and react for 1-3 hours. Then 60.0 g of sodium hydroxide solution (10%) is added with stirring slowly, and the resulting mixture is cooled to room temperature, and 13.3 g fungicide ACTICIDE MV is added and then the solid content is adjusted to 48-50% by demineralized water. Then the pH value is adjusted to 7-9 by sodium hydroxide solution (10%). Finally the volatile organic compounds in the product are removed by steam stripping.

The compositions of the polymer latex of the above examples and comparative are listed in Table 1.

TABLE 1
Compositions of polymers of the examples and comparative example

| | | | | | | | | | Coagulum, |
|---|---|---|---|---|---|---|---|---|---|
| | | | | water | | | | | ppm |
| | n-butyl | | | soluble | Solid | | | | (by |
| | acrylate, | butadiene | styrene | monomer, | content, | Viscosity, | | | 45 μm |
| Samples | wt % | wt % | wt % | wt % | wt % | mPa · s | pH | Tg° C. | sieve) |
| Comparative | 0 | 45 | 52.0 | 3 | 48-50 | 180 | 7.4 | −14.2 | 238 |
| example | | | | | | | | | |
| Example 1 | 10 | 37 | 50.8 | 2.2 | 48-50 | 92 | 8.3 | −11.0(shell)/ | 17 |
| | | | | | | | | −1.5 | |
| | | | | | | | | (core) | |
| Example 2 | 15 | 33 | 49.8 | 2.2 | 48-50 | 57 | 8.9 | −11.0(shell)/ | 15 |
| | | | | | | | | 3.3 | |
| | | | | | | | | (core) | |
| Example 3 | 20 | 29.5 | 48.3 | 2.2 | 48-50 | 121 | 7.5 | −10.6(shell)/ | 57 |
| | | | | | | | | 3.6 | |
| | | | | | | | | (core) | |

Liquid part and powder part are mixed together according to formulation in Table 2 with stirring for 3-5 minutes, and then the slurry is applied on PTFE plate with scraper to form a cementitious polymer waterproofing membrane at thickness of 2 mm. After 7 days, mechanical properties of the membrane are measured. The substrate used in the adhesion strength measurement is cement board.

TABLE 2
Formulation of cementitious polymer waterproofing membrane

| | |
|---|---|
| Components | Weight, g |

Liquid materials

| | |
|---|---|
| Polymer latex (50 wt %) | 274.4 |
| Defoamer (Lumiten EL) | 2 |

Powdered materials

| | |
|---|---|
| Cement | 216 |
| Quartz sand (100~200 mesh) | 349 |
| Quartz sand (270~320 mesh) | 157 |
| Superplasticizer (Tamol 8906) | 1.24 |
| Retarder (sodium gluconate) | 0.36 |
| Total | 1000 |

The mechanical properties of cementitious based polymer waterproofing membrane according to the examples and comparative example are listed in Table 3.

As shown in the Table 3, the examples 1-3 according to the present invention show substantial improvement with comparison to the comparative example in terms of adhesion strength, and the tensile strength and elongation at break of the invention are comparable or closer to that of the comparative example.

TABLE 3
Mechanical properties of cementitious polymer waterproofing
membrane according to the examples and comparative example

| | Comparative | | | |
|---|---|---|---|---|
| Samples | example | Example 1 | Example 2 | Example 3 |
| Adhesion strength, MPa | 0.94 | 1.25 | 1.31 | 1.38 |
| Tensile strength, MPa | 1.11 | 1.10 | 1.13 | 1.17 |
| Elongation at break, % | 80 | 61 | 66 | 64 |

In fact, the adhesion strength and tensile strength of the invention product are higher than those of the prior products in the markets, and the elongation at break is closer to that of the prior products, and in summary, the overall properties of the invention hybrid latex meet the requirement of balancing the strength and flexibility of the prior products.

It will be apparent to those skilled in the art that various modifications and variations can be made in the present invention without departing from the scope or spirit of the invention. Thus, it is intended that the present invention cover such modifications and variations as come within the scope of the appended claims and their equivalents.

1. A hybrid latex comprising polymeric particles having core-shell structure, wherein:
(1) the comonomers of the core comprise:
(a) monovinyl aromatic compounds, and
(b) unsaturated carboxylic acid esters;
(2) the comonomers of the shell comprise:
(a) monovinyl aromatic compounds, and
(b) conjugated dienes;
wherein a glass transition temperature of the core is from −50° C. to 50° C., and a glass transition temperature of the shell is from −50° C. to 50° C.

2. The hybrid latex according to claim 1, wherein the glass transition temperature of the core is from −20° C. to 20° C.

3. The hybrid latex according to claim 1, wherein the glass transition temperature of the shell is from −20° C. to 20° C.

4. The hybrid latex according to claim 1, wherein the unsaturated carboxylic acid ester is selected from C1-C8 alkyl (meth)acrylates.

5. The hybrid latex according to claim 4, wherein the unsaturated carboxylic acid ester is n-butyl acrylate.

6. The hybrid latex according to claim 1, wherein the monovinyl aromatic compound in (1) and (2) are each independently selected from the group consisting of styrene, methyl styrene, ethyl styrene, and combination thereof.

7. The hybrid latex according to claim 6, wherein the monovinyl aromatic compound is styrene.

8. The hybrid latex according to claim 1, wherein the conjugated dienes are selected from the group consisting of 1,3-butadiene, isoprene, 2-chloro-1,3-butadiene, and combination thereof.

9. The hybrid latex according to claim 8, wherein the conjugated diene is 1,3-butadiene.

10. The hybrid latex according to claim 1, wherein the comonomers of the core comprise 10-90 wt % of unsaturated carboxylic acid esters and 90-10 wt % of monovinyl aromatic compounds, and the weight percentages are calculated based on the total weight of the comonomers of the core and the sum of all comonomers of the core is 100 wt %; and
the comonomers of the shell comprise 10-90 wt % of conjugated dienes and 90-10 wt % of monovinyl aromatic compounds, and the weight percentages are calculated based on the total weight of the comonomers of the shell and the sum of all comonomers of the shell is 100 wt %.

11. The hybrid latex according to claim 1, wherein the core comprises 10-90 wt % of the weight of the polymeric particles, and the shell comprises 90-10 wt % of the weight of the polymeric particles.

12. The hybrid latex according to claim 1, wherein the polymeric particles have a particle size of from 80 to 300 nm.

13. The hybrid latex according to claim 1, wherein the comonomers of the core further comprise 0-10 wt % of monomers selected from the group consisting of (meth)acrylic acid, (meth)acrylamide, N-hydroxymethyl (meth)acrylamide, itaconic acid, maleic acid, fumaric acid, hydroxyethyl (meth)acrylate, hydroxypropyl (meth)acrylate, sodium vinyl sulfonate, sodium styrene sulfonate, acrylonitrile, glycidyl methacrylate, diacetone acrylamide, vinyltrimethoxy silane, γ-methacryloxy propyl trimethoxyl silane, allyl acrylate, 1,4-butanediol diacrylate, trihydroxymethyl propane triacrylate, pentaerythritol tetraacrylate, and combination thereof, and the weight percentages are calculated based on the total weight of the comonomers of the core and the sum of all comonomers of the core is 100 wt %.

14. The hybrid latex according to claim 1, wherein the comonomers of the shell further comprise 0-10 wt % of monomers selected from the group consisting of (meth)acrylic acid, (meth)acrylamide, N-hydroxymethyl (meth)acrylamide, itaconic acid, maleic acid, fumaric acid, hydroxyethyl (meth)acrylate, hydroxypropyl (meth)acrylate, sodium vinyl sulfonate, sodium styrene sulfonate, acrylonitrile, glycidyl methacrylate, diacetone acrylamide, vinyltrimethoxy silane, γ-methacryloxy propyl trimethoxyl silane, allyl acrylate, 1,4-butanediol diacrylate, trihydroxymethyl propane triacrylate, pentaerythritol tetraacrylate, and combination thereof, and the weight percentages are calculated based on the total weight of the comonomers of the shell and the sum of all comonomers of the shell is 100 wt %.

15. The hybrid latex according to claim 1, wherein the hybrid latex is suitable in polymer waterproofing membrane and polymer modified mortars.

16. The hybrid latex according to claim 15, wherein the polymer waterproofing membranes are cementitious polymer waterproofing membrane.

17. The hybrid latex according to claim 15, wherein the polymer modified mortars are selected from the group consisting of cement based tile adhesive, repair mortar, waterproofing mortar, self-leveling mortar, exterior thermal insulation adhesive mortar and decorative mortar, thermal insulation mortar, flooring mortar and cementitious bonding agents.
